(19) United States
(12) Patent Application Publication
(10) Pub. No.: US 2026/0148268 A1
(43) Pub. Date: May 28, 2026

(54) System for Privacy-Preserving Road Usage Charging

(71) Applicant: Southwest Research Institute, San Antonio, TX (US)

(72) Inventor: Michael Andrew Koets, San Antonio, TX (US)

(21) Appl. No.: 18/959,094

(22) Filed: Nov. 25, 2024

(51) Int. Cl. G06Q 30/04; G08G 1/0962

(52) U.S. Cl. CPC G06Q 30/04; G08G 1/0962; G06Q 2220/00; G06Q 2240/00

(57) ABSTRACT

A road usage charging system carried on-board a vehicle traveling on a roadway. The vehicle is assumed to be in wireless data communications with a billing agent having cryptographic authentication for its charge inquires and within range of a global navigation satellite system (GNSS). An on-board road usage charging system delivers information that allows drivers to be charged for the specific times and locations they use public roads. At the same time, the system provides protections for driver privacy.

### BACKGROUND OF THE INVENTION

Construction and maintenance of public roads is a significant expenditure of public funds. As a result, various transportation funding systems have developed.

Many policies and incentives are being implemented to encourage the use of fuel efficient and electric vehicles. Due to the shift, gasoline taxes are becoming less viable for funding roads. An additional reason for pursuing charging alternatives is to provide more equitable ways to pay for public roadways.

Tolling is the oldest form of usage-based fees. Tolling fees tend to cover specific roadway segments, tunnels, and bridges. Old-style toll stations have advanced to electronic toll collection systems.

“Road usage charging” is a more modern approach, directed to fees collected from vehicle owners that is proportional to their use of the public roadway network. Unlike tolls, road usage charging can apply to all public roadways within a jurisdiction such as a state. With road usage charging, the cost that drivers pay can be reduced from what they pay for tolls: up to a few pennies per mile as compared to much more per mile for tolls.

Many drivers may not consider a road usage charge itself to be particularly sensitive information, but they may be unwilling to reveal the specific road usages that generated the charge.

### BRIEF DESCRIPTION OF DRAWINGS

FIG. 1 illustrates a road usage charging system on-board a vehicle traveling on a roadway.

FIG. 2 illustrates data exchanges by and within the road usage charging system.

FIG. 3 illustrates the Trusted Compute module and the User Compute module each having its own GNSS receiver.

### DETAILED DESCRIPTION OF THE INVENTION

The following description is directed to a method and system for road usage charging. An on-board road usage charging system delivers information that allows drivers to be charged for the specific times and locations they use public roads. At the same time, the system provides protections for driver privacy. Accurate road usage charging can be guaranteed while preventing disclosure of travel patterns.

More specifically, the road usage charging system described herein collects information so that accurate travel data can be used to compute a road usage charge. The system does not require trust in the driver to report roadway usage.

### System Overview

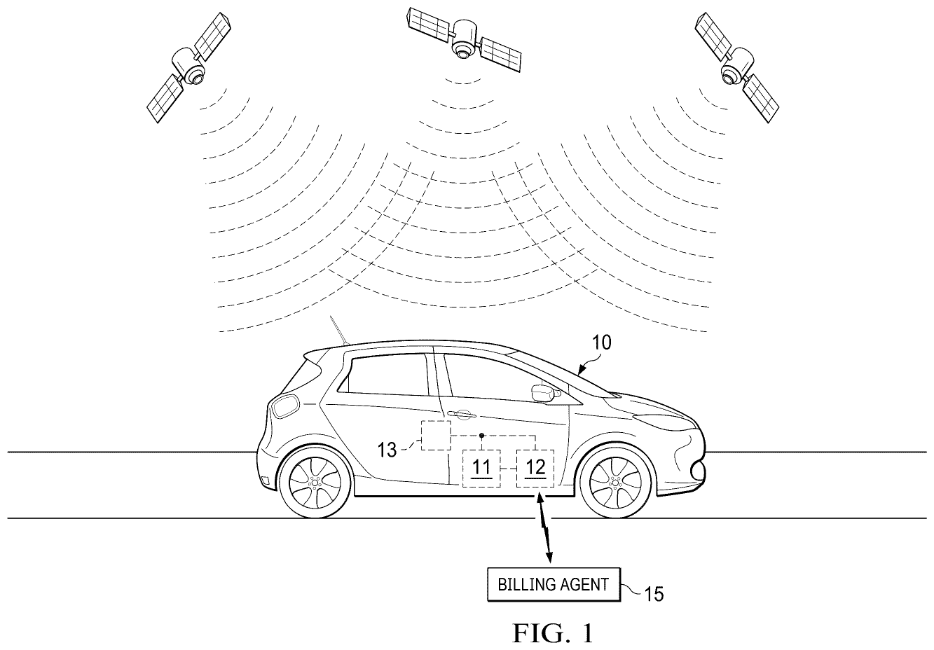

FIG. 1 illustrates a road usage charging system. A vehicle 10 is shown driving upon a road in a system of roadways whose usage is to be billed. It should be understood that the concepts described herein apply regardless of whether the vehicle's “driver” is an actual driver or whether the vehicle is autonomous. In either case, the “driver” is used herein to mean whomever is responsible for paying for usage, also referred to herein as the “user”.

A billing agent 15 is responsible for collecting usage data so that the driver can be billed. The billing agent 15 sets road usage rates, manages a list of users, and bills users.

It is assumed that vehicle 10 is within the range of a GPS (global positioning system) or other global navigation satellite system (GNSS) that provides positioning and timing services.

Vehicle 10 has on-board three devices relevant to this description, in addition to various other control, navigation, and other conventional hardware/software processes. These are a Trusted Compute (TC) module 11, a User Compute (UC) module 12, and a GNSS receiver 13. Both modules 11 and 12 are assumed to be equipped with whatever hardware (processing and memory) and software required to implement the processes described herein.

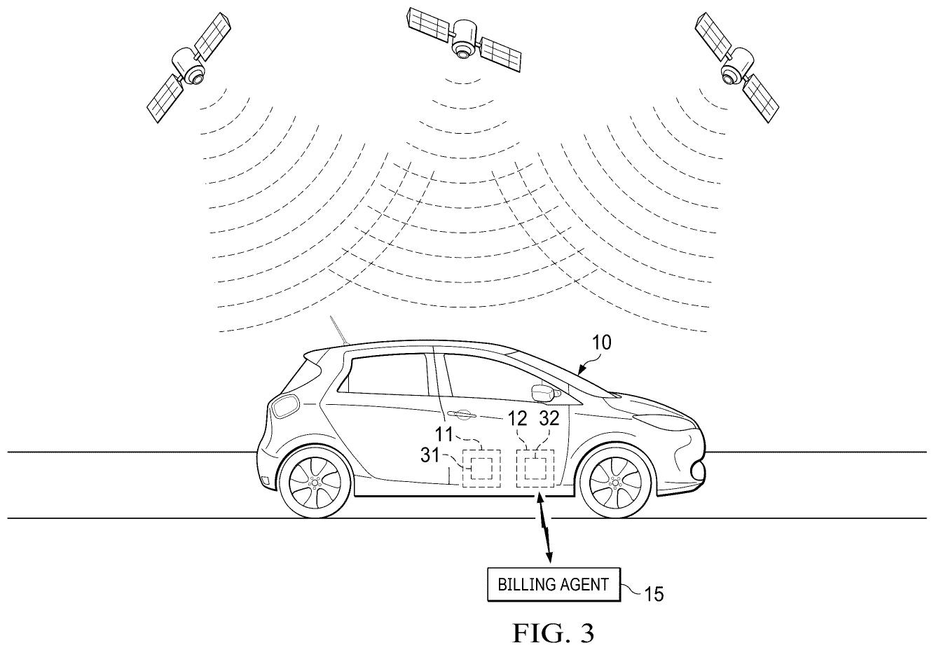

In FIG. 1, GNSS receiver 13 is shared by TC module 11 and UC module 12. In other embodiments, such as in FIG. 3, each module may have its own GNSS receiver, 31 and 32.

The various communications between billing agent 15 and User Compute module 12 described herein are assumed to be wireless communications and may be achieved by various wireless technologies. The Trusted Compute model 11 and User Compute module 12 are typically in proximity to each other and communications between those two devices is typically wired.

The billing agent 15 has the ability to communicate with the User Compute module 12. Periodically, the billing agent 15 sends inquiries to the User Compute module 12, asking it to report what charges the driver owes.

Trusted Compute module 11 performs the processes for road usage charging. Trusted Compute module 11 is tamper-resistant, making it difficult to physically break into for access to the electronics.

As further explained below, Trusted Compute module 11 is pre-programmed with a cryptographic public key provided by the billing agency 15 before installation on the vehicle. It also has a private cryptographic key installed or generated prior to installation. It implements a cryptographic data exchange protocol that allows accurate usage charging while protecting user data and provides protection against under-reporting of road usage.

Typically, Trusted Compute module 11 is manufactured and configured under the control of billing agent 15. This configuration (public key exchange) is typically done prior to installation on the vehicle, but it is also possible for this exchange to occur over a data communications network. Its behavior cannot be controlled by the user whose road usage it monitors. Trusted Compute module 11 incorporates the ability to monitor and record road usage, communicate with user compute module 12, and perform data storage and computation functions. Trusted Compute module 11 is not equipped to directly communicate with billing agent 15 during road usage monitoring.

User Compute module 12 hosts the Trusted Compute module 12 and is capable of communicating data with billing agency 15, typically via a wireless communications network. The User Compute module 12 also has the ability to communicate with the Trusted Compute module 11 as well as the ability to perform data storage and computation. The User Compute module 12 has the ability to monitor road usage independently of the Trusted Compute module 11, using GNSS capability.

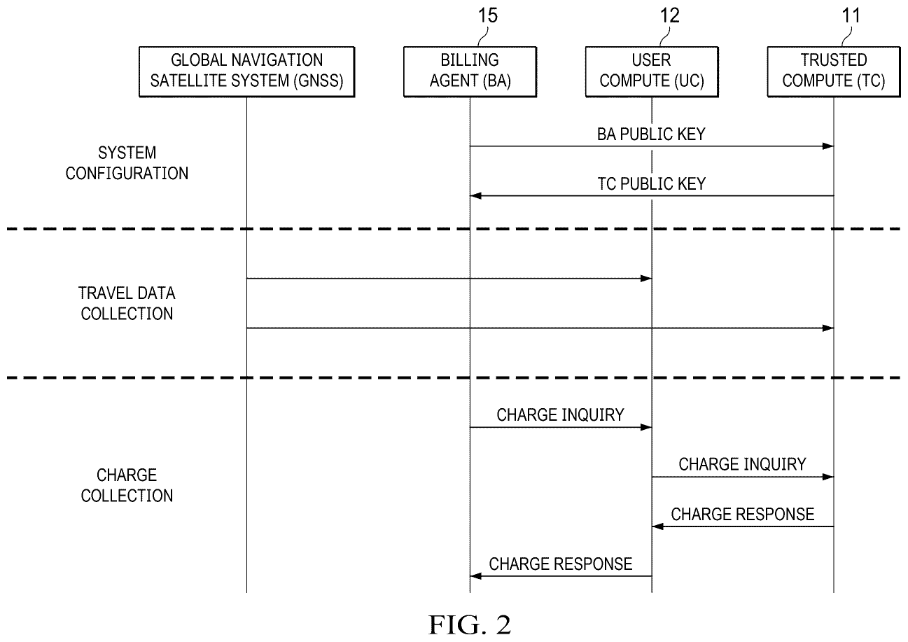

FIG. 2 illustrates the data exchanges between the Trusted Compute (TC) module 11, User Compute (UC) module 12, and billing agent (BA) 15.

During system configuration, and prior to communications connection between the Trusted Compute module 11 and the User Compute module 12, both the Trusted Compute module 11 and the billing agent 15 generate public and private keys for a public key encryption scheme. The billing agent's public key is stored in the Trusted Compute module 11. The Trusted Compute module's public key is stored by the billing agent 15. Alternatively, public keys may be generated and exchanged during operation using key exchange algorithms.

In operation, referred to as “travel data collection”, Trusted Compute module 11 gathers travel data from GNSS receiver 13 and stores this data internally in nonvolatile memory. The “travel data” includes road usage, which may be travel milage, what particular roads were traveled, duration of travel, and time of travel.

The User Compute module 12 also independently collects and stores travel data using the GNSS receiver 13. Thus, during the course of normal operation, the User Compute module 12 and Trusted Compute module 11 independently gather and record road usage data using their independent travel monitor functions. These road usage records are not shared between the User Compute module 12 and Trusted Compute module 11.

Periodically, the billing agent requests payment for road usage by sending a “charge inquiry” to User Compute module 12. User Compute module 12 receives these messages and a sends a charge inquiry request to Trusted Compute module 11, which computes the charges and provides them back in the form of a “charge response” to the User Compute module 12, which then forwards them on to the billing agency 15. After charge data has been delivered from the User Compute module to the billing agent 15, travel data contributing to those charges are deleted by the Trusted Compute module 11 and, optionally, by the User Compute module 12.

### Road Usage Charge Collection

Road usage charging is initiated when billing agent 15 generates a charge inquiry. It gathers and organizes road usage rates into a data message. Rates include any variations in unit charges, i.e. for time of use. A random query ID is generated and included in the data message. The charge inquiry is signed using a cryptographic authentication algorithm, such as the RSA (Rivest-Shamir-Adleman) cryptosystem, and the billing agent's private key.

The billing agent 15 transmits the signed charge inquiry to the User Compute module 12. The same inquiry may be issued to User Compute modules on other vehicles if desired.

The User Compute module 12 receives and performs initial processing on the charge inquiry. It extracts the road usage rates and computes the expected charge based on the extracted rates and its stored travel data.

The User Compute module 12 then forwards the charge inquiry to the Trusted Compute module 11, which processes the message. First, the Trusted Compute module 11 authenticates the message as legitimate using the message authentication information and the stored billing agent's public key. If the message is not authenticated, it is discarded.

The Trusted Compute module 11 extracts the road usage rates and a query ID from the authenticated charge query. It computes the charge using the road usage rates and its stored road usage data.

The Trusted Compute module 11 then prepares a charge response message containing the charge and the received query ID. It signs the charge response message using a cryptographic authentication algorithm, such as the RSA cryptosystem, and the Trusted Compute module's private key. The Trusted Compute module 11 then sends signed charge response to the User Compute module 12.

The User Compute module 12 compares the charge data in the Trusted Compute module's message to its locally computed charge data. If the charges do not agree, the message is discarded. If the charges agree, the charge response is sent to the billing agent 15.

The billing agent 15 verifies that the charge response was sent by the Trusted Compute module 11, using the stored Trusted Compute module's public key. If the message is not authenticated, it is discarded. If the message is authenticated, the billing agent 15 confirms that the query ID present in the charge response matches the transmitted query. If the query ID does not match, the message is discarded. If the query ID does match, the billing agent 15 extracts the charge data from the charge response and initiates billing of the user associated with that Trusted Compute module 11.

As a result of the above road usage charging method, user road usage data is never revealed to the billing agent 15, nor is it retained for long periods of time. The charging mechanism cannot be manipulated by sending fraudulent charge inquiries. The User Compute module 12 cannot reduce the charges by modifying the charge response without detection. The User Compute module 12 cannot reduce charges by replaying a previous charge response. Charging errors by the Trusted Compute module 11 can be detected by the User Compute module 12.

1. A computer-implemented road usage charging system carried on-board vehicles traveling on a roadway, within range of a global navigation satellite system (GNSS), comprising:
a computer-implemented billing agent that generates charge inquiries and implements cryptographic authentication for such inquiries;
a road usage system on-board each of the vehicles, comprising
At least one GNSS receiver operable to communicate directly with the billing agent;
a trusted compute (TC) processing module operable to perform the following tasks during a configuration mode: to receive a public key from the billing agent and to deliver a public key to the billing agent;
wherein the TC processing module is operable to collect TC travel data using the GNSS system as the vehicle travels and to calculate TC road usage charges based on the TC travel data;
a user compute (UC) processing module operable to collect UC travel data using the GNSS system as the vehicle travels and to calculate UC road usage charges based on the UC travel data;
wherein the UC module is further configured to receive charge inquiries from the billing agent, to forward the charge inquiries to the TC module, to receive charge responses from the TC module, and to forward the charge responses to the billing agent;
wherein the TC module authenticates the charge inquiries using the cryptographic authentication, prepares the charge responses containing the TC road usage charges, signs them using the cryptographic authentication, and delivers them to the user compute module;
wherein the UC module is further operable to compare the TC road usage charges to the UC road usage charges prior to forwarding the charges responses to the billing agent.

2. The system of claim 1, wherein the TC module is tamper resistant.

3. The system of claim 1, wherein the cryptographic system uses public and private keys.

4. The system of claim 1, wherein the TC module does not directly communicate with the billing agent except in the configuration mode.

5. The system of claim 1, wherein the travel data comprises one of more of the following: mileage, what road(s) were traveled, duration of travel, and time of travel.

6. The system of claim 1, wherein the TC module deletes travel data after a charge response is delivered.

7. The system of claim 1, wherein the at least one GNSS receiver is a single receiver shared by the TC module and the UC module.

8. The system of claim 1, wherein the at least one GNSS receiver are a GNSS receiver associated with the TC module and a GNSS receiver associated with the UC module.
